(19) United States
(12) Patent Application Publication
(10) Pub. No.: US 2002/0181237 A1
(43) Pub. Date: Dec. 5, 2002

(54) Shadowless reflector for an operation lamp

(76) Inventor: Jyh-Wei Liang, Taipei Hsien (TW)

Correspondence Address: BIRCH STEWART KOLASCH & BIRCH, PO BOX 747, FALLS CHURCH, VA, 22040-0747, US

(21) Appl. No.: 09/867,395

(22) Filed: May 31, 2001

(51) Int. Cl. F21V 7/00

(52) U.S. Cl. 362/297; 362/346; 362/347

(57) ABSTRACT

A reflector can be applicable to an operation lamp for providing light beams from a bulb through different paths and focusing along a centerline to an illuminated patch to provide a shadowless lighting. The reflector is composed of a plurality of three-dimensional curvy reflecting strips connected with one another circularly around the centerline of the lamp. The cross sections taken perpendicularly to the centerline are polygons. The sides of the polygon can be curves. The vertical sections taken along the centerline are symmetric continuous curves each composed of two to five curve portions linked together. Each curve portion is a high order mathematical function with multiple factors. The curve portions can provide light beams through different paths to the illuminated patch.

### BACKGROUND OF THE INVENTION

1. Field of Invention

The present invention generally relates to a shadowless operation or surgery lamp, and more particularly relates to an improvement of a shadowless reflector for an operation lamp by which the light coming from a bulb is suitably reflected through different paths to the illuminated surface. So that a part of the light paths being hindered by objects will not generate notable shadow on the illuminated surface, but the illuminated subject on the surface can still have adequate shadow for a normal depth of vision or stereo view.

2. Related Art

In order to obtain a shadowless lighting, an earlier operation lamp utilized a plurality of small reflectors with a bulb on each of them to form a lighting device The plurality of reflectors provide same sized circular light beams focusing on a same illuminated plane, so that when an object, such as a surgeon's head, hinders a part of the light, no notable shadow will be generated on the illuminated subject. Though the lighting device was effective, it had to be adjusted with the position and distance of the reflectors when the position of the lighting device to the illuminated subject was changed. The adjusting mechanism of the reflectors made the lighting device a bulky and heavy unit, which also made the adjustment inconvenient during surgical procedures.

An improvement for solving the aforesaid problem is disclosed by U.S. Pat. No. 6,135,602. The lighting device, as shown in FIGS. 1 through 3, includes a reflector 20 formed on inner surface of a shade 21. The reflector 20 is composed of a plurality of small reflecting planes 2010 equiangularly divided in the longitudinal and latitudinal direction. The reflecting planes 2010 reflect the light of a bulb 10 through different reflecting paths to the illuminated surface 30. The upper part of the reflecting planes 2010 locating near the upper center of the reflector 20 evenly provide intersecting lights to the illuminated surface 30, while the reflecting planes 2010 locating in the rim of the reflector 20 evenly provide non-intersecting lights to the illuminated surface 30. The intersecting and non-intersecting lights made the light beams come from different angles and overlap on the illuminated surface so as to eliminate the shadow of objects, such as the head 50 of a surgeon, that hinders a partial light beams 40.

Though the aforesaid patent can provide a shadowless lighting, it gives too many light spots, coming from those reflecting planes 2010 and partially overlapping one another on the illuminated surface 30, that still cause problem of human vision to the subject. Because human eyes need a certain shadow or sharp edge of the illuminated subject for obtaining a stereo view or depth of vision. When the subject being illuminated from too many angles, it loses shadow, i.e.. the edge is obscure, that the surgeon still be hard to identify the depth of the subject. Then, human eyes are easily fatigued with such “plane” lighting. This is quite a problem for application of the aforesaid patent.

### SUMMARY OF THE INVENTION

It is therefore an object of the present invention to provide a shadowless reflector for an operation lamp.

A further object of the present invention is to provide an improvement of a shadowless reflector that can remain adequate shadow of the illuminated subject for a stereo view.

To achieve the aforesaid objects, a reflector for an operation lamp according to the present invention improves the reflecting planes 2010 of the U.S. Pat. No. 6,135,602. The present invention greatly reduces the number of the reflecting planes, replaces with a plurality of three-dimensional curvy reflecting stripes connected with one another circularly around the centerline of the lamp. A cross section perpendicular to the centerline is a polygon with either straight line or curve as sides. The vertical sections taken along the centerline are symmetric continuous curves composed of two, three, four or five curve portions linked together. Each curve portion is defined by a high order mathmatical function (Polynomial equation) with multiple factors. This improved reflector can provide shadowless lighting from a bulb to the illuminated surface when a part of the light being hindered by bodies or objects, while still provide sharp lighting and adequate shadow to the subject on the illuminated surface, so that the subject may have shadow for a better and easier eye vision. For example, a surgeon can identify the operation subject clearly under this sharp lighting. This is advantaged from the simpler curvy reflecting planes that won't cause too many overlapped shadows of a specified feature.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention sill become more fully understood from the detailed description given hereinbelow illustration only, and thus are not limitative of the present invention, and wherein:

FIG. 1 is a graph showing light paths of a prior art surgery lamp;

FIG. 2 is a side view of the prior art surgery lamp showing a reflector composed a plurality of small reflecting planes;

FIG. 3 is a bottom view of the reflector of prior art surgery lamp;

FIG. 4 is a side view of a reflector of an operation lamp according to the present invention, and

FIG. 5 is bottom view of a reflector of an operation lamp according to the present invention

### DETAILED DESCRIPTION OF THE INVENTION

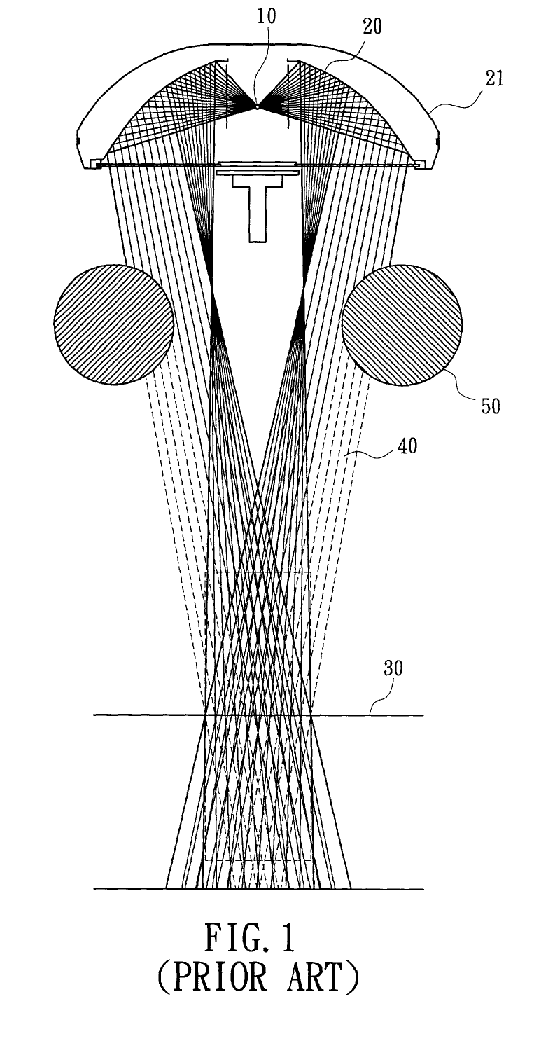

FIGS. 1 to 3 are explanatory views for a prior art surgery lamp that has been described above.

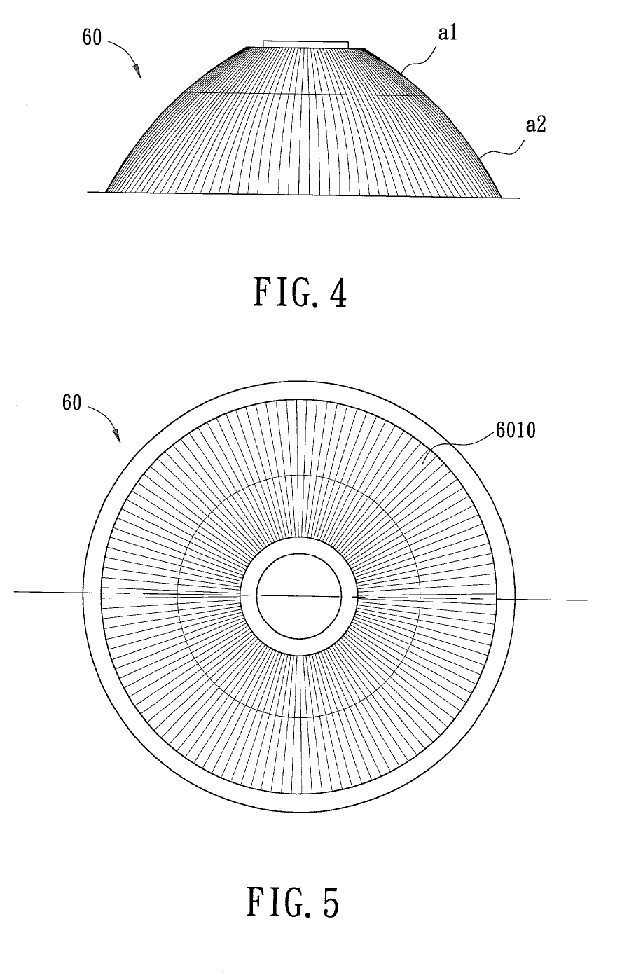

FIGS. 4 and 5 show the side view and bottom view of a reflector of an operation lamp according to the present invention. The reflector 60 includes a plurality of three-dimensional curvy reflecting stripes 6010 connected with one another circularly around the centerline of the lamp. The cross sections perpendicular to the centerline are polygons. The sides of the polygon can also be curves. The vertical sections taken along the centerline are symmetric curves each composed of two, three, four or five curve portions smoothly linked together (two curve portions a1, a2 are shown in the figures). Any of the curve portions can be defined by a high order mathematical function (Polynomial Equation) with multiple factors as follows.

$$z = {\sum }_{m = 0}^{M} {\sum }_{n = 0}^{N} {a}_{m n} {x}^{m} {y}^{n} , M N \geq 3$$

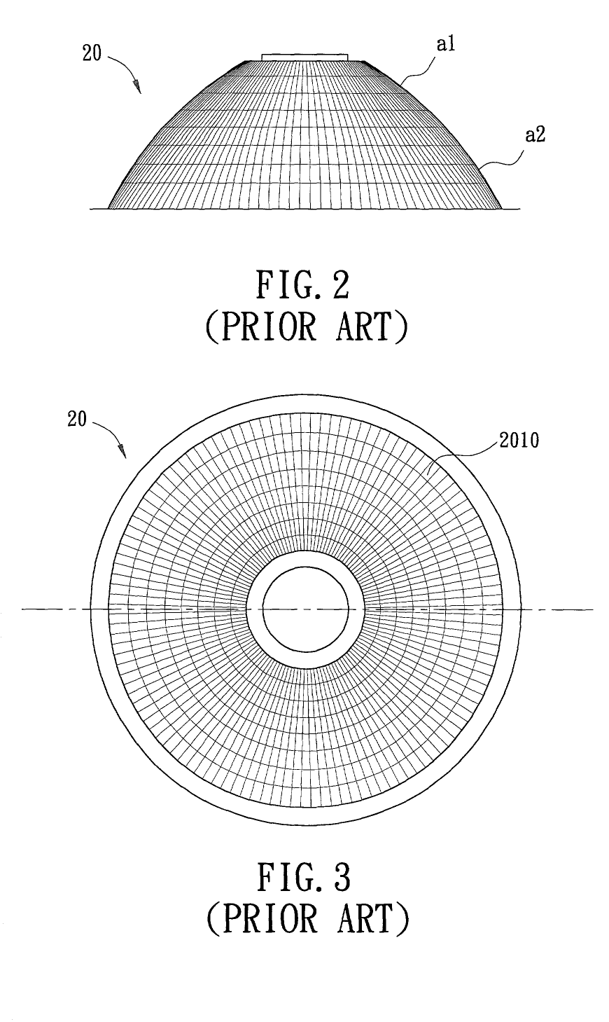

A preferred embodiment of the present invention is shown in FIG. 4. It improves the reflecting planes 2010 of the FIG. 2 of prior arts. This invention greatly reduces the number of the reflecting planes 2010, replaces with a plurality of of three-dimensional curvy reflecting stripes 6010 connected with one another circularly around the centerline of the lamp. As described above, the vertical sections taken along the centerline are continuous curves composed of several (for example, two) curve portions smoothly linked together. The upper curve portion al that locating near the upper center of the reflector 60 evenly provide intersecting lights to the illuminated patch, while the lower curve portion a2 that locating near the rim of the reflector 60 evenly provide non-intersecting lights to the illuminated patch. This improved reflector 60 can provide shadowless lighting from a bulb to the illuminated patch when a part of the light being hindered by bodies or objects, such as head or instruments of the surgeon.

Like a common operation lamp, the distance between the bulb and the reflector 60 has to be adjustable for focusing the light to the illuminated surface according to the required distance. Practically, the adjustable distance is within 0.8 to 1.3 meters.

The difference between the present invention and the prior art U.S. Pat. No. 6,135,602 is mainly the composition of light beams on the illuminated surface. In the prior art, an illuminated point on the illuminated surface 30 may obtain light beams from several adjacent reflecting planes 2010. In other words, adjacent light spots overlap to each other, so that the illuminated subject will lose its shadow or depth of vision and will be hard for clear viewing. While in this invention, any point on the illuminated patch is only illuminated by one beam from the upper curve portion a1 and one beam from the lower curve portion a2. No overlapping beams will provide to a point from a single curve portion a1 or a2. Therefore, the light beams can provide sharp lighting and generate adequate shadow to the subject locating within the illuminated patch For example, a surgeon can clearly view the stereo detail of the operation portion by the sharp contour and certain shadow.

Through the three-dimensional curve reflecting stripe 6010 of the present invention includes two to five curve portions, in order to enlarge the covering angle of light reflection, the first curve portion a1 and its adjacent curve portion a2 are connected with same normal lines and same slopes at the connection point.

In conclusion, the reflector of the present invention is composed of a plurality of three-dimension curvy reflecting strips 6010 that are simpler than the matrixes of large amount small reflecting planes 2010 of the U.S. Pat. No. 6,135,602. The reflector 60 can be more easily fabricated into a unit than the prior arts.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A reflector applicable to an operation lamp for providing light beams from a bulb through different paths and focusing along a centerline to an illuminated patch to provide a shadowless lighting, comprising a plurality of three-dimensional curvy reflection stripes connected with one another circularly around the centerline

2. A reflector for an operation lamp according to claim 1 wherein any cross section perpendicular to the centerline is a polygon.

3. A reflector for an operation lamp according to claim 2 wherein the sides of the polygon of a cross section are curves.

4 A reflector for an operation lamp according to claim 1 wherein a vertical section taken along the centerline are symmetric continuous curves each composed of at least two curve portions, defined with high order mathematical functions, linked together

5. A reflector for an operation lamp according to claim 4 wherein each said continuous three-dimensional curve includes an upper curve portion locating near an upper center of the reflector for evenly providing intersecting lights to the illuminated patch.

6. A reflector for an operation lamp according to claim 4 wherein each said continuous three-dimensional curve includes a lower curve portion locating in the rim of the reflector for evenly providing non-intersecting lights to the illuminated patch.

7. A reflector for an operation lamp according to claim 4 wherein the upper curve portion and the adjacent curve portion of the three-dimensional curvy reflecting stripe are connected with same normal lines and same slopes at the connection point.

8. A reflector for an operation lamp according to claim 4 wherein the three-dimensional continuous curve is composed of two to five curve portions.

9. A reflector for an operation lamp according to claim 1 wherein a distance from the lowest rim of light head housing to the illuminated patch is within 0.8 to 1.3 meters.

10. A reflector for an operation lamp according to claim 1 wherein a distance from the lowest rim of light head housing to the illuminated patch is 1 meter

11. A reflector for an operation lamp according to claim 1 is fabricated as a unit that can not be disassembled.
